(19) United States
(12) Patent Application Publication
(10) Pub. No.: US 2003/0194112 A1
(43) Pub. Date: Oct. 16, 2003

(54) Iris-recognizable mouse device, computing device using the same and method for authenticating computing device

(76) Inventor: Won Hee Lee, Buchum-si (KR)

Correspondence Address: BIRCH STEWART KOLASCH & BIRCH, PO BOX 747, FALLS CHURCH, VA, 22040-0747, US

(21) Appl. No.: 10/414,032

(22) Filed: Apr. 16, 2003

(30) Foreign Application Priority Data
Apr. 16, 2002 (KR) 2002-0020696

(51) Int. Cl. G06K 9/00

(52) U.S. Cl. 382/117

(57) ABSTRACT

The present invention discloses an iris-recognizable mouse and a computing device using the mouse. The mouse comprises an iris recognizing means for recognizing a user's iris and a communication interface USB port. An iris image processing means for processing the user's iris image can be mounted on the mouse or a computer. The iris recognizing means is comprised of a camera and at least one light sources in the vicinity of the camera. Preferably, a small-sized camera and light sources are used. The mouse and the computing device of the present invention can be advantageously used for reducing power consumption and for performing user authentication more quickly because the user can simply bring the mouse close to his/her eyes personally and there is no need to measure the distance between the user and the system or to focus.

### BACKGROUND OF THE INVENTION

1. Field of the Invention

The present invention generally relates to iris recognition, and more particularly, a device for recognizing an iris more conveniently by providing a mouse with an iris recognition function.

2. Discussion of the Related Art

There have been a number of systems for security, crime prevention, and identity authentication, starting from the traditional contact cards system or the non-contact cards system, the fingerprint recognition system, and up to the iris recognition system. These all serve to authenticate a person's identification before allowing or denying the person's access to a particular place or data.

Among those, the iris recognition system is highly considered for its excellent recognition rate and high accuracy, compared with the fingerprint recognition.

The iris recognition system authenticates a person by comparing a pre-registered iris data with a new iris data that has been prepared by photographing the person's iris images with a video camera and creating characteristic iris patterns into data using an image process technique.

FIG. 1 is a block diagram illustrating the configuration of an iris recognition system of the related art.

To explain how the iris recognition system of FIG. 1 operates, when a user approaches the iris recognition system 10, a distance measurement sensor 27 measures the distance between the user and the system

The measured value for distance is sent to a controller 19, and the control unit decides whether the measured value is within a certain distance to be able to operate the system 10.

If it turns out that the user is within the distance for operating the system 10, the controller provides a control signal to a driver 23.

The driver 23 generates an active signal and sends the signal to an external indicator 25. The external indicator 25, in response to the active signal, indicates to the user that the system 10 is in operation.

When the user puts his or her eyes on an optical axis of a camera 15 through an optical window 11, a cold mirror 13 intercepts visible rays and passes infrared rays.

At this time, the optical window 11 shows where the user's eyes are supposed to be, and the system checks if the user's eyes are properly placed at the positions indicated on the optical window 11.

Provided the user's eyes are accurately located at the positions indicated on the optical window 11, the controller 19 operates the distance measurement sensor 27 one more time to measure the distance between the user's eyes and the optical window 11 and receives the measured value for distance from the sensor. The controller 19, using the measured value, calculates zoom and focus values of the camera 15 to perform zoom in/zoom out and focusing control.

Later, the controller 19 sends a camera control signal to the camera 15 to control the camera to photograph the user's iris image.

The photographed iris image is processed by a frame grabber 17 where an image for the system is generated. Thusly generated iris image is sent to the controller 19, and the controller 19 compares this iris image with the pre-registered iris image of the user in an iris database 29, to authenticate the user's identity.

In general, performance of the iris recognition system of the related art is graded depending on how fast and how accurately it can recognize an iris.

Besides, in case a single light source is used in the iris recognition system, secondary reflection occurs because of glasses.

To obviate the secondary reflection due to glasses, using a plurality of light sources was suggested. According to this method, the user's iris image can be obtained by changing locations of the light sources.

Recently, this type of iris recognition system has been adapted to personal computers.

In general, the iris recognition system is installed in a personal computer, more particularly in a peripheral portion of the personal computer, as a separate device.

This means that if a user wants to use the iris recognition system, the user should come to the system and focus personally.

Many users soon realized that it is not so convenient to approach the iris recognition system every time they need to be authenticated.

What is more inconvenient for users than approaching the iris recognition system is maintaining a constant distance from the camera. However, keeping the constant distance every time is not easy, and unsystematic or irregular authentication by the iris recognition system has only added to the users inconvenience.

Also, to apply the iris recognition system of the related art to a personal computer, there are other devices required, for example, a distance measurement sensor for measuring distance to the user or a circuit device for processing the measured value for distance. In addition, as a plurality of light sources are used to avoid possible reflection from the glasses of the user, the volume of the system was increased more than necessary, and power consumption for operating the system was also increased proportionately.

### SUMMARY OF THE INVENTION

An object of the invention is to solve at least the above problems and/or disadvantages and to provide at least the advantages described hereinafter.

Accordingly, one object of the present invention is to solve the foregoing problems by providing a movable mouse with an iris recognition function to achieve higher recognition rate.

Another object of the present invention is to provide a mouse for performing iris recognition with low power consumption by mounting a small-sized iris recognizing means onto the mouse.

Another object of the invention is to provide a computing device for performing user authentication faster and more accurately by transferring iris images that are captured by the iris recognizing means mounted on the mouse to a computer via a USB (Universal Serial Bus) port.

Still another object of the invention is to provide a computing device for performing user authentication more conveniently by producing a mouse that can perform iris recognition to user authentication.

The foregoing and other objects and advantages are realized by providing a mouse device including: an iris recognizing means for recognizing a user's iris image, the iris recognizing means being placed at a predetermined position on a surface of the mouse device, and a communication interface for providing the user's iris image that is recognized at the iris recognizing means to outside.

The iris recognizing means includes: a camera for photographing the user's iris image, and at least one light source with adjustable intensity according to a location of illumination to be irradiated to the user's iris, the light sources being disposed in the vicinity of the camera.

According to a second preferred embodiment of the present invention, a mouse device includes: an iris recognizing means for recognizing a user's iris image, the iris recognizing means being placed at a predetermined position on a surface of the mouse device, an iris image processing means for performing user authentication using the user's iris image that is recognized at the iris recognizing means, and a communication interface for providing a result of user authentication performed at the iris image processing means to outside.

According to a third preferred embodiment of the present invention, a computing device includes a mouse composed of an iris recognizing means for recognizing a user's iris image, and a first communication interface for providing the user's iris image that is recognized at the iris recognizing means; and a computer composed of a second communication interface for receiving the user's iris image from the first communication interface, an iris image processing means for performing user authentication using the received user's iris image to the second communication interface, and a controlling means for taking proper measures according to a result of user authentication performed at the iris image processing means.

According to a fourth preferred embodiment of the present invention, a computing device includes a mouse composed of an iris recognizing means for recognizing a user's iris image, an iris image processing means for performing user authentication using the user's iris image that is recognized at the iris recognizing means, and a first communication interface for providing a result of user authentication performed at the iris image processor, and a computer composed of a second communication interface for receiving the result of user authentication from the first communication interface, and a controlling means for taking proper measures according to the result of user authentication that is received to the second communication interface.

According to a fifth preferred embodiment of the present invention, a method recognizing a user's iris image in a computing device includes the steps of: providing, at a mouse, the user's iris image being photographed to a computer, performing user authentication at the computer, using the iris image provided to the computer, and taking proper measures, at the computer, in accordance with a result of the user authentication.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram illustrating the configuration of an iris recognition system of the related art;

FIG. 2 is a perspective view depicting the outward appearance of a mouse according to the present invention;

FIG. 3 is a schematic diagram illustrating the structure of an iris recognizable mouse according to a preferred embodiment of the present invention;

FIG. 4 is a schematic diagram illustrating the structure of a computing device mounted with the iris recognizable mouse according to another preferred embodiment of the present invention;

FIG. 5 is a schematic diagram illustrating the structure of an iris recognizable mouse according to another preferred embodiment of the present invention; and

FIG. 6 is a schematic diagram illustrating the structure of a computing device mounted with the iris recognizable mouse according to yet another preferred embodiment of the present invention.

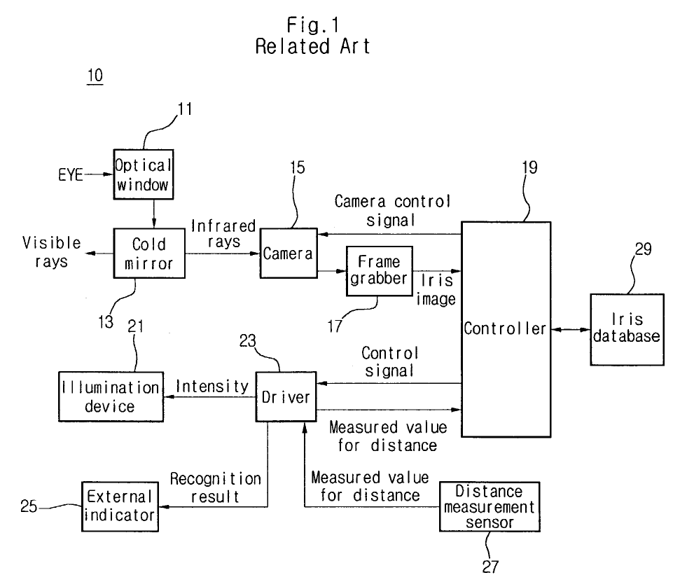

### DETAILED DESCRIPTION OF PREFERRED EMBODIMENTS

The following detailed description will present an iris recognizable mouse and a computing device mounted with the iris recognizable mouse according to a preferred embodiment of the invention in reference to the accompanying drawings.

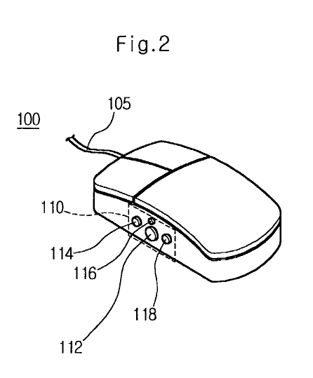

FIG. 2 is a perspective view depicting the outward appearance of a mouse according to the present invention.

As shown in FIG. 2, the mouse 100 of the present invention has an iris recognizer 110 for recognizing the iris image of a user at a predetermined position on the mouse's surface.

The predetermined position indicates a position where the user's hand (or fingers) does not get in the way. In fact, the iris recognizer 110 can be placed anywhere on the mouse as long as it is not impeded by the user's hand. For example, if the user is left-handed, the iris recognizer 110 can be placed on the right side of the mouse 100. Similarly, if the user is right-handed, the iris recognizer 100 can be placed on the left side of the mouse 100.

Usually, the mouse 100 is connected to a communication cable through which it can be connected to an external device, such as, a computer.

The iris recognizer 100 includes a camera 112 for photographing the user's iris images, and at least one light source 114, 116, and 118 for adjusting the intensity of light from an illumination device to the user's iris, the light sources being located in the vicinity of the camera 112.

Particularly, the light sources 114, 116, and 118 could be one of luminous elements (e.g. LED element, organic EL element and the like), halogen lamps or xenon lamps.

The light sources 114, 116, and 118 are disposed around the camera 112, and preferably, each of the light sources is located at a different position.

For instance, suppose that there are three light sources 114, 116, and 118. In such case, one light source can be placed on the left side of the camera, another light source on the right side of the camera, and the other light source on the top of the camera, respectively. Although the present invention introduced using three light sources as described above, it should not be taken as a limit but as an illustration.

In fact, there are many benefits one can get from using the mouse with the iris recognizer. All the user has to do is to bring the mouse very close to his/her eyes. In so doing, a multi-mega pixel camera with a high quality is not needed any more since the distance between the user and the optical window does not have to be measured. Moreover, because the distance between the user and at least one of the light sources 114, 116 and 118 is very close, the light sources do not need to be too bright. As such, a small sized camera 112 and light sources 114, 116 and 118 are sufficient to get the user's iris image. Accordingly, less power, namely 5V voltage and 500 mA current, is used to operate the camera 112 and the light sources 114, 116 and 118, and power consumption can be remarkably reduced also, compared to that of the related art.

The light sources 114, 116, and 118 at different positions can perform iris recognition under different situations as well. For example, if the user is wearing glasses, secondary reflection from the glasses might occur. Still it is possible to perform iris recognition more accurately in this case by having each light source illuminate light one by one in response to a reflection angle due to the secondary reflection from the glasses.

The following gives more details on the mouse having the iris recognizer.

[Embodiment1]

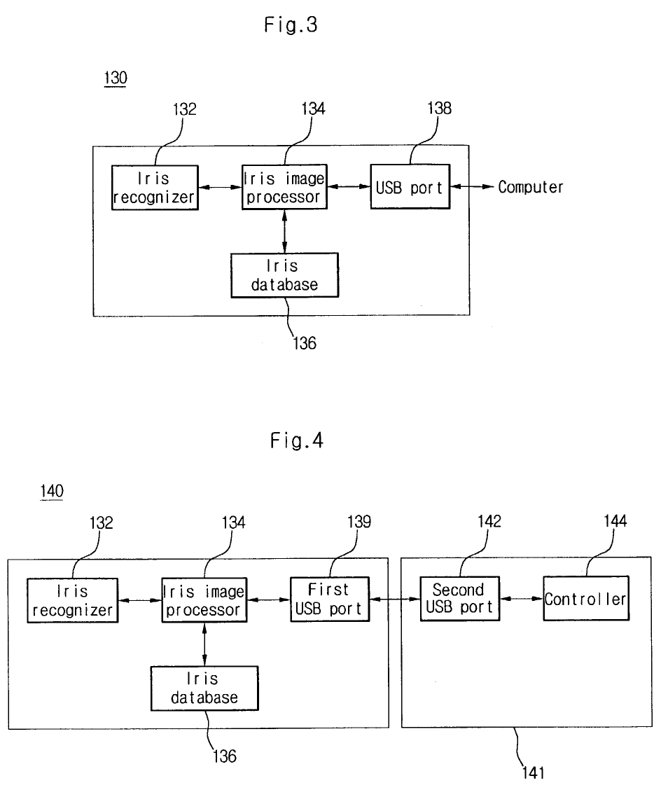

FIG. 3 is a schematic diagram depicting the structure of an iris-recognizable mouse according to a preferred embodiment of the present invention.

Referring to FIG. 3, the mouse 130 includes an iris recognizer 132 for recognizing the user's iris image, an iris image processor 134 for performing user authentication based on the iris image being recognized by the iris recognizer 132, and a USB port 138 for providing a result of user authentication performed by the iris image processor 134 to an external device, namely a computer.

The mouse 130 further includes an iris database 136 to which iris images to be provided to the iris image processor 134 are pre-registered. The iris database 136 stores (or is supposed to have) all iris images of users who use the mouse 130. In case the iris image of a certain user using the mouse 130 has not been registered to the iris database 136, authentication of the corresponding user fails.

The iris recognizer 132, as described in FIG. 3, is located at a certain position on the surface of the mouse 130, and at least one light source 114, 116 and 118 is disposed around the camera 112.

The iris image processor 134 extracts characteristic patterns from the iris images that are recognized by the iris recognizer 132 and generates an iris image based on the patterns. Then, the iris image processor 134 compares the generated iris image to the pre-registered iris image provided by the iris database 136, to authenticate the user.

USB port 138 is an interface for exchanging data between other peripheral devices. Since the USB port 138 does not require an additional driver but is able to transfer data high rate data, its usage has been increased rapidly.

Having the USB port 138 built in the mouse, the user authentication result in the iris image processor 134 can be provided to the computer.

The following explains a case where the mouse is applied to the computer.

FIG. 4 is a schematic diagram of the computing device mounted with the iris-recognizable mouse according to another preferred embodiment of the present invention.

As depicted in the drawing, the computing device 140 is composed of a mouse 130 including an iris recognizer 132 for recognizing a user's iris image, an iris image processor 134 for performing user authentication based on the iris image that is recognized by the iris recognizer 132, and a 1^{st} USB port 139 for providing a result of user authentication performed at the iris image processor; and a computer 141 including a 2^{nd} USB port 142 for receiving the result of user authentication from the 1^{st} USB port 139, and a controller 144 for taking proper measures in accordance with the result of user authentication that is received to the 2^{nd} USB port 142.

The mouse 130 further includes an iris database 136 to which iris images to be provided to the iris image processor 134 are pre-registered.

The mouse 130 has the identical structure with the mouse illustrated in FIG. 3. Particularly, the 1^{st} USB port 139 is equivalent to the USB port 138 of FIG. 3, acting as an interface for providing the result of user authentication performed at the iris image processor 134 to the computer 141.

As described above, the computer 141 includes the 2^{nd} USB port 142 and the controller 144. The controller 144 checks the result of user authentication and if the user authentication is succeeded, allows the user to access to the computer 141. For instance, the user should be authenticated to be able to use data in the computer 141, to do web surfing over Internet, and to share data with other devices through the computer.

To explain how iris recognition is done in the computing device having the above structure, the user first brings the iris recognizer 132 of the mouse 130 very close to his/her eyes for authentication.

Then one of the plural light sources (refer to 114, 116 and 118 of FIG. 2) irradiates light to the user, and a camera (refer to 112 of FIG. 2) photographs the user's iris image and provides the image to the iris image processor 134.

The iris image processor 134 extracts characteristic patterns from the iris image the camera 112 photographed, generates an iris image based on the extracted patterns, and compares the generated iris image to the pre-registered iris image provided from the iris database 136 for performing user authentication.

When user authentication fails, another light source of the plural light sources 114, 116 and 118 irradiates light to the user again, and the camera 112 photographs the user's iris image.

Again, the iris image processor 134 performs user authentication on this image.

If user authentication is succeeded, the result of user authentication is provided to the 2^{nd} USB port 142 of the computer 141 through the 1^{st} USB port 139.

The result of user authentication being provided to the 2^{nd} USB port 142 is sent to the controller 144 where proper operations are carried out in accordance with the result. That is, when the user is authenticated, the controller 144 allows the user to access to the computer 141.

As described above, with the help of the computing device using the iris-recognizable mouse, user authentication can be easily done, i.e. the user simply brings the mouse close to his/her eyes to be authenticated, and the user is able to access to a computer immediately.

Moreover, a high recognition rate for users can be obtained, and applying small-sized camera and light sources to the mouse, the structure of the iris-recognizable mouse does not have to be complicated and expensive.

[Embodiment 2]

In this embodiment, the iris images having been recognized at the iris recognizer can be sent directly to the computer for user authentication without being processed in the mouse first.

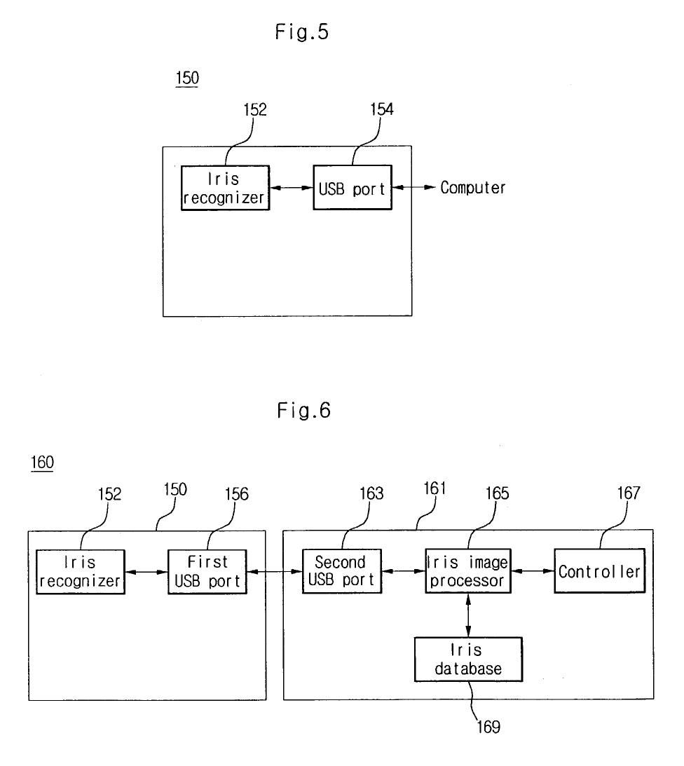

FIG. 5 is a schematic diagram illustrating the structure of the iris-recognizable mouse according to another preferred embodiment of the present invention.

As shown in FIG. 5, the mouse 150 includes an iris recognizer 152 for recognizing a user's iris image and a USB port 154 for providing the iris image from the iris recognizer 152 to an external device, namely a computer. The iris recognizer 152 is installed in a certain position on the surface of the mouse 150, where the iris recognizer does not get in the way of the user's hand holding the mouse 150.

As described with reference to FIG. 2, the iris recognizer 152 includes a camera 112 for photographing iris images, and at least one light source 114, 116 and 118 for adjusting the intensity of light, being irradiated to the user's iris, according to the locations of the lights. Here, the light sources 114, 116 and 118 can be put in different positions from one another.

The following describes a computer to which the mouse with the above construction is applied.

FIG. 6 is a schematic diagram illustrating the structure of a computing device mounted with an iris-recognizable mouse according to still another preferred embodiment of the present invention.

Referring to FIG. 6, the computing device 160 is composed of a mouse 150 including an iris recognizer 152 for recognizing a user's iris image and a 1^{st} USB port 156 for providing the user's iris image being recognized at the iris recognizer 152; and a computer 161 including a 2^{nd} USB port 163 for receiving the user's iris image from the 1^{st} USB port 156, an iris image processor 165 for performing user authentication using the received iris image from the 2^{nd} USB port 163, and a controller 167 for talking proper measures in accordance with a result of user authentication performed at the iris image processor 165.

The computer 161 further includes an iris database 169 to which iris images to be provided to the iris image processor 165 are pre-registered.

Basically, the mouse 150 has the identical structure with the mouse illustrated in FIG. 5. Particularly, the 1^{st} USB port 156 is equivalent to the USB port 154 of FIG. 4, which is an interface for providing the iris images being recognized at the iris recognizer 152 to the computer 161.

As aforementioned, the computer 161 includes the 2^{nd} USB port 163, the iris image processor 165, the controller 167 and the iris database 169. The controller 167 extracts characteristic patterns from the iris image that is provided by the 2^{nd} USB port 163, generates an iris image based on the extracted patterns, and compares the generated iris image to the pre-registered iris image provided from the iris database 136 for performing user authentication.

When user authentication fails, the user's iris image is photographed once more by controlling the iris recognizer 152 of the mouse 150 and changing the locations of the light sources. Then, user authentication is performed again based on the photographed iris image being received through the 1^{st} and 2^{nd} USB ports 156 and 163.

On the other hand, if user authentication is succeeded, the result of user authentication is provided to the controller 167, and the controller 167 performs proper operations in response to the result. That is, the controller 167 allows the authenticated user to access to the computer 161.

To explain how iris recognition is done in the computing device having the above structure, the user first brings the iris recognizer 152 of the mouse 150 very close to his/her eyes for authentication. More specifically, one of the plural light sources (refer to 114, 116 and 118 of FIG. 2) irradiates light to the user, and a camera (refer to 112 of FIG. 2) photographs the user's iris image at the same time.

The photographed iris image is sent to the 2^{nd} USB port 163 of the computer 161 through the 1^{st} USB port 156, and the 2^{nd} USB port 163 provides the iris image to the iris image processor 165.

The iris image processor 165 extracts characteristic patterns from the iris image the camera had photographed, generates an iris image based on the extracted patterns, and compares the generated iris image to the pre-registered iris image provided from the iris database 136 for performing user authentication

When the user is authenticated, the result of user authentication is sent to the controller 167, and the controller 167 allows the user to access to the computer 161.

If user authentication fails, however, another light source of the plural light sources 114, 116 and 118 of the iris recognizer 152 irradiates light to the user's iris, and photographs the user's iris again using the camera 112. Heaving received this iris image through the 1^{st} and 2^{nd} USB ports 156 and 163, the iris image processor then perform user authentication one more time. Therefore, when user authentication fails, the light sources 114, 116 and 118 are used in sequence to irradiate light to the user's iris, and the user's iris image is photographed every time light is irradiated to the user's iris. Thusly photographed iris image is sent to the iris image processor 165 of the computer 161 to be authenticated.

To be short, with the help of the computing device using the iris-recognizable mouse, user authentication can be easily done, i.e. the user simply brings the mouse close to his/her eyes for authentication at the same time, and the user is able to access to a computer immediately.

Moreover, a high recognition rate for users can be obtained, and applying small-sized camera and light sources to the mouse, the structure of the iris-recognizable mouse does not have to be complicated and expensive.

Also, having the iris processor and the iris database built in the computer, the load on the mouse is much reduced.

In conclusion, now that the mouse is equipped with the iris recognizing means, namely the camera and at least one light source, all the user needs to do to be authenticated is to bring the mouse close to his/her eyes. In this manner, user authentication can be performed more quickly than in the related art where the user had to approach the iris recognition system personally and to adjust a camera lens in consideration of the distance between the user and the lens.

Using the mouse of the present invention, a small-sized camera and light sources can be employed, consuming much reduced power compared to the related art.

Moreover, according to the computing device using the iris-recognizable mouse of the present invention, the iris-recognizable mouse device can be produced as a single unit. This is because the mouse is capable of performing user authentication based on the user's iris image, the image being provided by the iris recognizing means, and it is decided whether or not to allow the user to access to the computer, depending on the result of user authentication provided to the computer through the USB port. Any user is now able to connect the mouse to a computer more easily and can be authenticated to access to the computer.

Another advantage of the computing device using the iris-recognizable mouse of the present invention is that the structure of the iris recognition system is simplified and the load on the mouse is greatly reduced by mounting an iris recognizing means and a USB port onto the mouse and having the computer perform user authentication on a user's iris image that is recognized at the iris recognizing means.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A mouse device comprising:
an iris recognizing means for recognizing a user's iris image, the iris recognizing means being placed at a predetermined position on a surface of the mouse device, and
a communication interface for providing the user's iris image that is recognized at the iris recognizing means to outside.

2. The mouse device according to claim 1, wherein the iris recognizing means comprises:
a camera for photographing the user's iris image, and
at least one light source with adjustable intensity according to a location of illumination to be irradiated to the user's iris, the light sources being disposed in the vicinity of the camera.

3. The mouse device according to claim 1, wherein the light sources are disposed at different positions from one another.

4. The mouse device according to claim 1, wherein the predetermined position is a position where a hand of the user holding the mouse does not hinder operation of the iris recognizing means.

5. The mouse device according to claim 1, wherein the communication interface is an universal serial bus port.

6. A mouse device comprising:
an iris recognizing means for recognizing a user's iris image, the iris recognizing means being placed at a predetermined position on a surface of the mouse device,
an iris image processing means for performing user authentication using the user's iris image that is recognized at the iris recognizing means, and
a communication interface for providing a result of user authentication performed at the iris image processing means to outside.

7. The mouse device according to claim 6, wherein the iris recognizing means comprises:
a camera for photographing the user's iris image, and
at least one light source with adjustable intensity according to a location of illumination to be irradiated to the user's iris, the light sources being disposed in the vicinity of the camera.

8. The mouse device according to claim 6, further comprising:
an iris database to which iris images that are provided to the iris image processor are pre-registered.

9. A computing device comprising:
a mouse comprising:
an iris recognizing means for recognizing a user's iris image, and
a first communication interface for providing the user's iris image that is recognized at the iris recognizing means; and
a computer comprising:
a second communication interface for receiving the user's iris image from the first communication interface,
an iris image processing means for performing user authentication using the received user's iris image to the second communication interface, and
a controlling means for taking proper measures according to a result of user authentication performed at the iris image processing means.

10. The computing device according to claim 9, wherein the computer further comprises:
an iris database to which iris images that are provided to the iris image processing means are pre-registered.

11. The computing device according to claim 9, wherein the iris recognizing means comprises:
a camera for photographing the user's iris image, the camera being placed at a predetermined position on a surface of the mouse, and
at least one light source with adjustable intensity according to a location of illumination to be irradiated to the user's iris, the light sources being disposed in the vicinity of the camera.

12. A computing device comprising:
a mouse comprising:
an iris recognizing means for recognizing a users iris image,
an iris image processing means for performing user authentication using the user's iris image that is recognized at the iris recognizing means, and
a first communication interface for providing a result of user authentication performed at the iris image processor; and
a computer comprising:
a second communication interface for receiving the result of user authentication from the first communication interface, and
a controlling means for taking proper measures according to the result of user authentication that is received to the second communication interface.

13. The computing device according to claim 12, wherein the mouse further comprises:
an iris database to which iris images that are provided to the iris image processing means are pre-registered

14. The computing device according to claim 12, wherein the iris recognizing means comprises:
a camera for photographing the user's iris image, the camera being placed at a predetermined position on a surface of the mouse, and
at least one light source with adjustable intensity according to a location of illumination to be irradiated to the user's iris, the light sources being disposed in the vicinity of the camera.

15. The computing device according to claim 12, wherein the iris recognizing means is placed at a position where a hand of the user holding the mouse does not hinder operation of the iris recognizing means.

16. A method recognizing a user's iris image in a computing device, the method comprising the steps of:
providing, at a mouse, the user's iris image being photographed to a computer,
performing user authentication at the computer, using the iris image provided to the computer, and
taking proper measures, at the computer, in accordance with a result of the user authentication.

17. The method according to claim 16, further comprising the step of:
if the user authentication fails, performing user authentication again by controlling a position of at least one light source that is pre-mounted on the mouse.
